(19) United States
(12) Patent Application Publication
(10) Pub. No.: US 2003/0200632 A1
(43) Pub. Date: Oct. 30, 2003

(54) Ergonomic spring suspension carry handle for luggage

(76) Inventor: Gregg Schneider, Edina, MN (US)

Correspondence Address: Gregg Schneider, P.O. Box 24895, Minneapolis, MN, 55424, US

(21) Appl. No.: 10/118,305

(22) Filed: Apr. 8, 2002

(51) Int. Cl. E05B 1/00

(52) U.S. Cl. 16/444

(57) ABSTRACT

The invention is an ergonomic spring carry handle for luggage that reduces the strain imposed on the person carrying the article. The handle is useable over a wide load range without modification while producing a substantial reduction in user fatigue. The invention may be incorporated into new manufacture or retrofitted to repair or improve existing cases and bags. The invention includes a U-shaped handle having legs that pivot both parallel and perpendicular to the long axis of the graspable portion. The graspable portion includes a spring which may be a close-wound coil extension spring or other type, the ends of which are attached to the legs of the handle.

### RELATED APPLICATIONS

n/a

### GOVERNMENT SPONSORED RESEARCH

n/a

### FIELD OF INVENTION

This invention relates to graspable handles for carrying luggage, generally, and specifically to carrying handles for carrying briefcases, computer cases, carry-on luggage, and similar items. More particularly, the present invention is an ergonomic, strain-reducing carrying handle for briefcases, computer cases, sample cases, luggage, and other articles that are carried by hand.

### BACKGROUND

Previously known luggage handles have a variety of deficiencies that cause difficulties for the person who uses the luggage. Often, the handles are uncomfortable to grip. Handles may be too small and therefore cause pain to the user's hands. Some luggage handles lack sufficient strength and durability to withstand full loads or long-term use.

People who travel frequently may require features in luggage that are unnecessary for persons who seldom travel. Business travelers often need to carry a briefcase with documents and other work-related items and a separate item of luggage containing clothing and other travel necessities. Such individuals may pack the briefcase rather heavily to contain the many items required to conduct work for a week or more while also minimizing the number of separate articles of luggage that are used during a trip.

Travelers are often obliged to carry their own heavily packed luggage for extended distances through airports, city streets, and buildings. Strained muscles and joints are maladies frequently-encountered by travelers. Pain caused by muscle and/or skeletal injuries usually makes it difficult to work at peak efficiency, and in severe cases, it may be impossible to work at all.

A painfully strained muscle can often be caused by a momentary, even slight, additional stress placed on a person who may already be fatigued, over-loaded, off-balance, or otherwise near maximum tolerable exertion. Such additional stress may be caused by accidentally bumping into another person, a stationary object, or another item of luggage. Although such events might initially seem insignificant or merely transitory, they can be particularly dangerous if they come at a time when the individual is already close to the limit of his or her capacity. The magnitude of such additional stress on persons can be significant. The force exerted by a handle against the hands, arms, and shoulders of a person carrying a case through a crowded area can greatly exceed the weight of the article being carried as the result of jostling past other individuals and objects.

In addition, the force that a person must exert to carry a case is not at all constant. The amount of strain caused to an individual by the act of carrying an object such as an article of luggage by a handle may be evaluated as the combination of the static load and the dynamic load. While standing, the peak force would correspond to the weight of the case. When a person begins walking, the body rises and falls requiring the person to exert some increased force to prevent the load from falling with each step which is to say that the peak force that a person must exert will very often exceed the weight of the article being carried. With each step, the arms, shoulders, trunk, legs, and feet move relative to one another, to the terrain and the load being carried. Those movements, especially the vertical movement of the trunk and shoulders, require the person carrying an article to react by constantly varying the carrying force in order to maintain balance and grasp and compensate for the gravitational force against the body and the load being carried.

The magnitude of the peak reaction forces a person must exert in order to continue holding an article and maintain balance can be higher if the terrain is uneven or if objects cause stumbling or strike the article being carried. Both the weight of the object being carried and maximum force it exerts are important factors in assessing the degree of fatigue, stress, or injury likely to result from carrying it. It can be appreciated, then, that if variations in the vertical path through space are minimized, the person carrying the case will need to perform less work lifting the case from one elevation to another. Of course, it is normal to have some variation in the height at which the object is carried. By reducing the jarring force that occurs at the maximum elevation increase of each step, it is possible to substantially reduce the stress and injury that can result from carrying a fully loaded case.

Other workers in the field have sought to overcome the problem of uncomfortable luggage handles. For example, cushioned handles are described in U.S. Pat. No. 5,560,083 to Teixeria, issued Oct. 1, 1996. He describes a handle made of two lengths of webbing having the longitudinal edges sewn together to form a flexible hollow cylinder. A filler material core is built up beginning with a central piece of resilient stiffening wire, a plastic tube coaxial to the wire, and a wrapping of about three layers of resilient foam strip. Teixeria does not disclose a means for minimizing the maximum force exerted by the carry handle against the hand of the person carrying the case.

U.S. Pat. No. 4,754,858 issued Jul. 5, 1988 to Robinson for a Cushioning Pad for Luggage Handles. Uncomfortable luggage handles are so common that Robinson designed a cushioning pad that can be transferred from one case to another.

U.S. Pat. No. 4,016,315 to Szabo dated Apr. 5, 1977 shows a handle with an optional steel leaf spring in the core that provides only for stiffening the cushioned grip and for returning the handle to an orientation flat against the mounting surface when not in use.

Other patents have issued for cushioned, substantially U-shaped, carrying handles, including U.S. Pat. No. 3,813,729 to Szabo et al. issued Jun. 4, 1974; U.S. Pat. No. 3,692,155 to Laurita issued Sep. 19, 1972, and; U.S. Pat. No. 3,656,594 to Marks et al. issued Apr. 18, 1972. Each of these patents shows cushioning for the hand-contacting portions.

The known prior art does not show a carry handle that provides a resilient member to effectively reduce the maximum force to which the person carrying the case is subjected by suspending the load being carried by a spring suspension system that is effective over a very wide range of loads without adjustment or objectionable increase in the distance between the grip and the article being carried.

### SUMMARY

What is needed then is a handle that can reduce the magnitude of the transitory and periodic peak forces that are exerted against the hands, arms and shoulders of a person as the result of variations in terrain, body elevation, jostling and contact with objects while carrying an article of luggage. What is further needed is a simple handle that is capable of suspending the load being carried with a spring suspension system that is effective over a very wide range of loads without the necessity of making adjustments and without an objectionable increase in the distance between the grip and the article being carried.

This disclosure shows a grippable carry handle assembly for attachment to a luggage case comprising two spaced-apart articulating case attachment fixtures, two links, each link having a case end portion articulatingly connected to a case attachment fixture and a tie end portion attached to an elongated grippable cross-member portion having a first end articulatingly connected to the first link tie end and a second end articulatingly connected to the second link tie end, the cross-member being further comprised of; a first deflectable portion resiliently responsive to force applied to a link in excess of a first initial tension, a second deflectable portion resiliently responsive to force applied to a link in excess of a second initial tension, a third deflectable portion resiliently responsive to force applied to a link in excess of a third initial tension, a sheath portion generally radially surrounding the cross-member, and an elongated hand-contacting surface generally surrounding the sheath portion.

This disclosure presents a handle that includes at least one extension spring member that deflects arcuately and extends in response to greater load or force on the handle. In one embodiment, a generally U-shaped handle is comprised of two spaced-apart fixed-length links, or legs, with articulating connection to the case and an elongated hand-contacting member comprised of a close-wound extension spring extending between the links at the end opposite the case.

In another embodiment, the legs of the “U”-shaped handle include springs that extend and contract in response to varying load. In yet another embodiment, the elongated hand-contacting member includes a leaf spring that can deflect in response to the load exerted on the links by the case.

In one embodiment, by way of example and not by way of limitation, a close-wound coil of 0.0625 to 0.125 inch diameter spring steel wire approximately 1 to 1¼ inch diameter and 5 inches long can be attached between leg portions of a sturdy conventional U-shaped handle that are hinged to a case. It may be desirable to permit the links to articulate both perpendicular and parallel to the elongated axis of the spring when making the connection between the spring and the legs and between the legs and the case. That method of attachment makes it possible for a single spring element to provide useful shock reduction over an extremely wide range of loads.

This effect results from the fact that the close-wound extension coil spring, when oriented horizontally, supported in the middle will bend, generally arcuately at the middle, relatively easily in response to load applied to the ends. Adjacent coils above the middle support will separate at the upper side while remaining in contact at the bottom. Coils at the ends will not deflect until greater load is applied sufficient to overcome the initial tension of the spring. When the spring is supported nearer the ends, the lever arm is shorter requiring greater force to deflect adjacent coils from contact. When a light load is being carried, it is quite natural to support the handle with a relaxed grip using primarily the middle fingers. When the case is more heavily loaded, all of the fingers are naturally and automatically used to make a stronger grip on the handle, increasing the amount of force required to cause initial arcuate deflection.

Further increasing the load on the arcuately deflected handle will overcome the initial tension and cause the spring to extend longitudinally in addition to curving the axis. The useful load carrying range of the handle is thus greater than would be available using a single rate extension spring. This configuration makes it possible to use a single component to provide shock reduction when the case is lightly loaded, when it is quite heavily loaded and at all intermediate loads. The configuration also makes it possible to have this very desirable broad load range capability without increasing the distance between the case and the hand to an objectionable or uncomfortable degree. It is to be understood that it is not desirable for the distance between the hand and the case to vary substantially.

Factors important in specifying the spring include the initial tension of the close-wound spring (the force tending to keep the coils of an extension spring closed which must be overcome before the coils start to open), the length of the active portion, the length of any loops, hooks, or other features at the ends of the coils for attachment of the spring to the case or other handle components, the diameter of the active portion, the direction of the load, wire diameter, and the shape of the coil. Stiffness of the spring is also affected by the material from which it is made, and by treatments applied to it. If the coil is constant diameter, or cylindrical, the maximum practical diameter will be somewhat less than the largest diameter handle that persons find comfortable to grasp, in order to allow space for a covering, or sheath, to be applied over the coils. In some embodiments, a coil having a larger diameter in the middle and a reduced diameter toward the ends may be more comfortable to grip and may be more easily configured for attachment to cases and interconnection with other components of a complete handle assembly.

It is believed preferable to configure the handle so that when it is being used by a person to carry a case, the hand grasps the middle portion of the grippable portion of the handle with the fingers contacting the bottom of the elongated grippable portion, or cross-member. At each end of the cross-member there is attached an elongated link. The cross-member end of the link may be attached to the cross-member with an articulating connection. The case end of each link may be attached to the case with an articulated connection, also. If the links are generally parallel or spaced-apart somewhat more at the case ends, the gravitational force of the case will be generally down, and the lifting force will be applied to the bottom, or case side of the cross-member. The links and cross-member form a shape analogous to an inverted “U” with the links equivalent to the legs (or arms) and the cross-member equivalent to the web.

By providing articulating connections for joining the graspable cross-member to the case, strain-relief spring cushioning is available to the person carrying the case because the cross-member is free to deflect along the longitudinal axis before the load is sufficient to overcome the initial tension. If the person carrying the case distributes the grip to lift the case from points closer to the ends of the cross-member, the cross member will deflect only when a greater downward force is applied. It is to be noted that the effect is to provide a spring-cushioned grip over a relatively large load range without increasing spring travel or the spacing between the case and the hand of the person carrying the case. If the load further increases, the initial tension will be overcome and the coils will deflect giving greater cushioning at the greatest loading, when it is most needed.

Although many advantages accrue from using the disclosed carry handle and there may be many reasons for the superior comfort it provides, it should be noted that the present handle fits more comfortably because its shape subjects the hand to less strain than do many conventional handles. It may be worthwhile to consider a person in the normal luggage carrying posture—arm at the side, hand down, fingers curling over the palm. Because the middle one or two fingers are almost always longer than either the index or the little finger, the middle two fingers will provide little or no contribution to load-carrying when the handle being grasped is arched in the manner of an inverted “U” which is a very common form for luggage handle design. An inverted “U” handle puts most of the load on the smallest finger and the index finger, urges them inward, and may require the person carrying the case to support the little finger and the index finger with the two middle fingers. Those contortions may be uncomfortable or merely more stressful than necessary.

A cylindrical handle is often more comfortable than a “U”-shaped handle because all fingers can contact the handle surface and the handle does not pinch the fingers together. It should be noted that the handle of this present disclosure may be coiled from a spring that has a bulge in the middle to better conform to the hollow of a person's hand and provide a graspable surface that urges the fingers neither together nor apart.

It is possible to use the handle with no covering, but a covering of leather, polyvinyl chloride, nylon, or other material may be desirable to provide enhanced comfort and appearance, to facilitate attachment to the case, and to prevent items from being pinched between adjacent coils. It has been learned that a sheath for the coils does not need to be thick. A satisfactory and very serviceable covering can be made from one or two layers of elastic 6 mil polyvinyl chloride tape. Other coverings including heat-shrinkable tube, built-up foam, cloth, leather, molded, and fused synthetics can be applied to achieve desirable tactile and visual properties. It should also be noted that the handle may be fabricated from square or other rectangular cross-section wire. Such wire may be advantageous to make assembly easier, to enhance the useful life of the sheath material by reducing localized pressures, or to make the hand-contacting portion of a handle more comfortable.

Cushioning material of polymer foam, textile, rubber, leather, or other compositions may be interposed between the cross-member and the hand-contacting surface of the carry handle assembly. The cushioning material may be protected by outer coverings or inner coverings to reduce wear caused by contact with the cross-member and with the hands of the persons who use the invention.

Thus is shown a grippable carry handle assembly for attachment to a luggage case comprising two spaced-apart case attachment fixtures, two links, each link having a fixture end portion connected to a case attachment fixture and a tie end portion attached to, an elongated grippable portion having a first end connected to the first link and a second end connected to the second link, the grippable portion being further comprised of a deflectable portion responsive to force applied to a link, an elongated tie portion having a first end affixed to the first link tie end and a second end affixed to the second link tie end, a sheath portion generally radially surrounding the tie portion, and an elongated hand-contacting portion generally surrounding the sheath portion. A close-wound, extension-type coil spring, can comprise the elongated tie portion, the coil spring being deflectable responsive to carrying force applied to a link. Alternatively, the links may be further comprised of coil springs that extend responsive to applied carrying force.

In another alternative embodiment, the elongated tie portion is further comprised of a resilient material such as a leaf of spring steel that is deflectable generally perpendicularly to the elongated axis responsive to carrying force applied to a link.

Other alternative equivalent component configurations may be employed to produce a carry handle for luggage that includes variable rate (or progressive) spring functionality without departing from the scope of the present invention. For example, the elongated grippable portion may be comprised of one or more spring leaves having varying lengths and/or cross-sections to produce a desired spring rate response curve. Additional spring elements may be consecutively engaged to increase the spring rate as load is increased. Toggles, levers, cams, and angled mounting can be used to obtain desirable spring response. It is possible to produce a non-linear spring rate by varying the diameter of the wire from which a coil spring is wound, by varying the diameter of the coil, by varying the distance between adjacent coils (in the case of compression springs), or by any combination of these techniques. In addition, the end finish of the spring (e.g. loop, straight wire, separated coil, hook, etc.) and the length of any lever arm or torque-transmitting feature can affect the rate at which a spring deflects in response to loading.

A simple spring usually responds to loading in some linear manner. For example, if an ordinary spring deflects one inch when a load of ten pounds is applied, the same simple spring would deflect about two inches with a twenty pound load and four inches under a forty pound load. That property is useful in many applications such as the manufacture of scales, door closers, and other apparatus. When it is necessary to suspend loads that vary greatly, however, as in the case of a truck tractor or an article of luggage, a linear spring rate capable of cushioning the full load will either provide no suspension when empty or else the linear travel distance of the suspension system will be impractically great.

In contrast, a variable rate spring suspension might deflect five millimeters with a five kilogram load, eight millimeters under a ten Kg load and ten millimeters when twenty Kg is applied. Although this type of variable rate provides cushioning at both low load and full load conditions, shock relief at full loads may be less than optimum. In this example, a bump or sudden jar that imposes an additional ten Kg load might deflect the suspension only another two millimeters. This effect is unfortunate, at the time when the person carrying a fully loaded article is under greatest load-bearing stress, the conventional variable rate suspension system provides the least relief, or compensation, in response to additional loads that may be induced by traffic, bumping, or the like.

The variable rate load response of the present luggage carry handle is unlike previously known carry handle systems. The person using a handle according to this disclosure can obtain a comfortable suspension of the load, with adequate strain relief at any load by naturally and nearly automatically varying the way the luggage handle is grasped.

It is an object of the invention to provide a new carry handle for luggage, especially briefcases, that reduces adverse symptoms of muscle/skeletal injuries associated with carrying luggage.

It is another object of the invention to provide an ergonomic carry handle for luggage that may be fitted to existing articles of luggage to effect repairs or improvements.

It is a further object of the invention to provide a handle for springingly supporting an article of luggage.

It is another object of the invention to provide a comfortable, durable, economical luggage handle.

It is another object of the invention to provide a carry handle having a wide range of useful loads.

It is yet a further object of the invention to provide a carry handle having a generally or substantially cylindrical hand-contacting portion.

### BRIEF DESCRIPTION OF THE DRAWINGS

FIG. 1 is a side elevation of an embodiment of the ergonomic spring suspension carry handle for luggage installed on an article of luggage, shown partially.

FIG. 2 is a side elevation detail of the ergonomic spring suspension carry handle of FIG. 1 depicting the mode of deflection when the luggage is empty.

FIG. 3 is a side elevation detail of the ergonomic spring suspension carry handle of FIG. 1 depicting the mode of deflection with a light load.

FIG. 4 is a side elevation detail of the ergonomic spring suspension carry handle of FIG. 1 depicting the mode of deflection with a heavy load.

FIG. 5 is an alternative embodiment of the ergonomic spring suspension carry handle of FIG. 4.

FIG. 6 is a second alternative embodiment of the ergonomic spring suspension carry handle of FIG. 4.

FIG. 7 is an alternative embodiment of the ergonomic spring suspension carry handle of FIG. 2.

FIG. 8 is an end elevation of another alternative embodiment of the ergonomic spring suspension carry handle.

### DETAILED DESCRIPTION

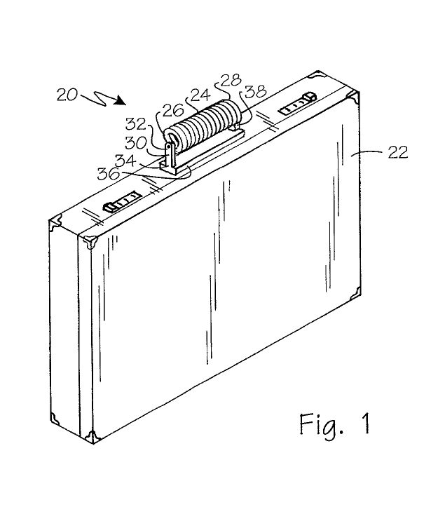

Referring now to the drawings and viewing first FIG. 1, there is shown an overview of an embodiment of the grippable ergonomic spring suspension carry handle 20 for attachment to luggage 22. Although the luggage 22 shown is a briefcase, it is to be understood that the carry handle 20 can be used with suitcases, toolboxes, sample cases, instrument cases, garment bags, and other articles that are carried by hand, all of which is referred to in this disclosure as luggage.

The carry handle 20 has an elongated, grippable cross-member portion 24 that has a first end 26 and a second end 28. A first link 30 has a tie end 32 articulatingly connected to the cross-member first end 26 and a case end 34 articulatingly connected to a case attachment fixture 36. A second link 38 may be identical to the first link 30 for connecting the cross-member second end 28 to the case attachment fixture 36.

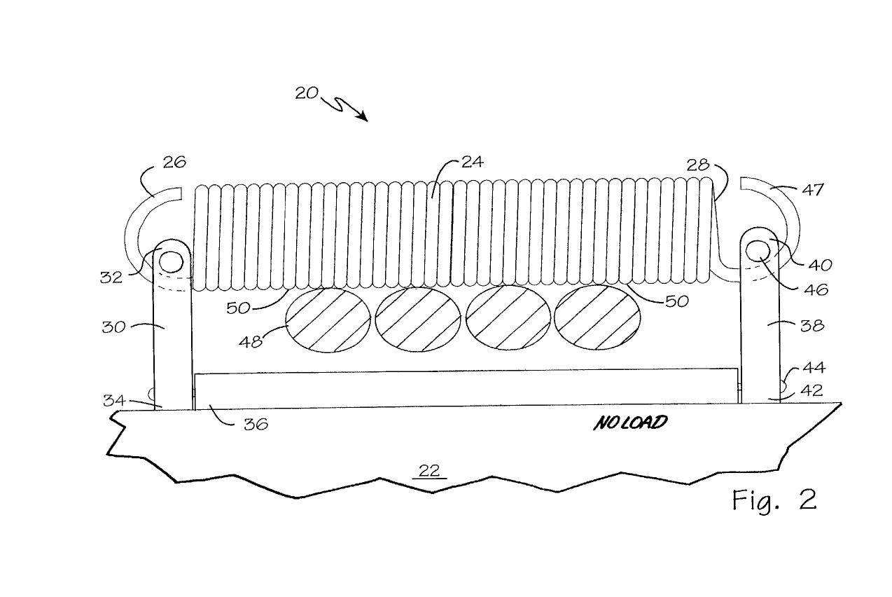

FIG. 2 shows the carry handle 20 in greater detail. The second link 38 tie end 40 and case end 42 are interposed between the grippable cross-member second end 28 and the case attachment fixture 36. The first link 30 and second link 38 are normally identical, but need not be. To simplify the disclosure, it is to be understood that references to a link 30 and elements comprising a link include the second link 38 except where otherwise stated. An articulating connection connects the links 30 38 to the luggage 22. The articulating connection may be a resilient portion of a unitarily formed case attachment fixture 36, a hinge pin 44, a slider, a swivel, socket, or other equivalent structures, some of which are depicted, by way of example and not by way of limitation, in subsequent drawing figures. The tie end 32 of the link 30 can include any type of fastener that will mate with the end of the cross-member 24 and may include a portion of the link 30 or of the end 26 of the cross-member 24. Link tie end fastener portions such as pivot pins 46 are shown for mating with loops or other mating fastener portions 47 formed at, or otherwise affixed to, the ends 26 28 of the cross-member 24. Other equivalent structures include, without limitation, portions of the cross-member 24, hinges, springs, sockets, apertures, and other mating fastener assemblies. Sufficient articulation may be provided by many different unitary or assembled components to all the cross-member to deflect properly responsive to the force exerted by the fingers 48 of the person carrying the luggage 22.

In FIG. 2, the handle 20 is shown with no (or a very light) load applied characteristic of an empty briefcase or other article of luggage 22. The adjacent coils of the typical close-wound, coil-type extension spring comprising the elongated grippable cross-member 24 are in direct physical contact. There is no extension of the spring because the load does not exert sufficient force to overcome the initial tension of the spring.

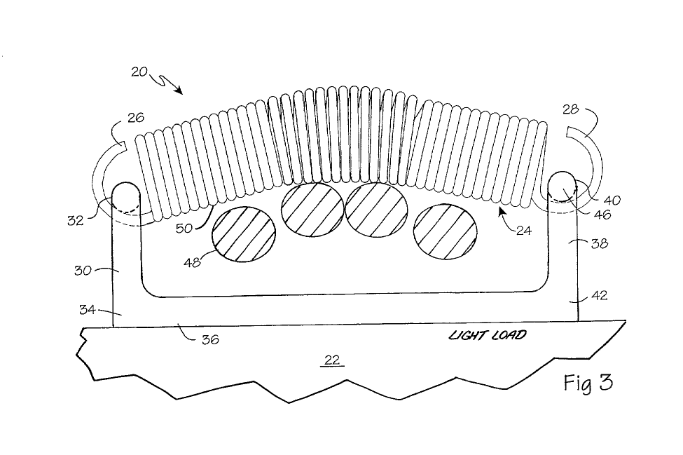

FIG. 3 shows the deflection of the elongated grippable cross-member portion 24 of the carry handle 20 responsive to a light load. The deflection is greatest at the mid-point and is characterized by coils contacting at the bottom portion and separating at the upper portion of the cross-member 24. The illustration shows that most of the weight is supported by the two middle fingers 48 of the person carrying the luggage 22 and that those fingers contact the cross-member 24 only proximate the mid-point which maximizes the length of the lever arm on which the load transmitted from the luggage 22 through the links 30 can act to cause deflection.

In the embodiment of the spring suspension carry handle 20 shown in FIG. 3, the case attachment fixture 36 is formed integrally with the links 30 38. It is not be essential that the links 30 38 articulate at both the tie end 32 40 and the case end 34 42, but it is likely possible to make the handle assembly 20 lighter and more compact if the assembly is designed to articulate at either or both ends of the links 30 38. As illustrated, the case attachment fixture 36 may be of resilient material such as spring steel, polymer such as injection-molded nylon, composite materials, the resilient material being used to effect movement of the components relative to one another (articulation). Alternatively, the links 30 38 can be formed integrally with the case attachment fixture 36 of a rigid material such as cast aluminum that would allow articulation only at the tie ends 32 40 in response to forces between the luggage 22 and the cross-member 24.

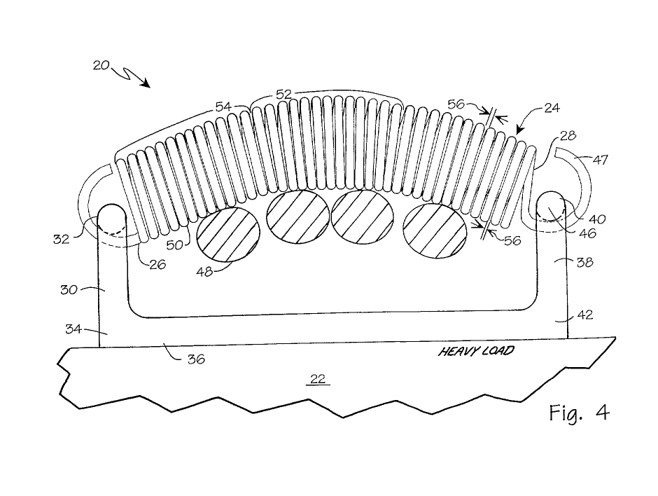

FIG. 4 depicts the deflection response of the carry handle 20 to a heavy load. There is deflection of the cross-member 24 present in the first deflectable portion 52 (the axially medial approximately ⅓ of the elongated cross-member 24, generally) which deflects in the same manner depicted in FIG. 3 when the load exceeds a first initial tension. The heavier load is supported by all four fingers 48 of the person carrying the luggage 22. The outer two fingers 48 are situated closer to the ends 26 28 of the elongated cross-member 24 which reduces the length of the lever arm on which the load can act to cause deflection.

Thus, the deflection characterized by coils contacting at the bottom (finger-contacting) portion and separating at the upper portion of the cross-member 24 occurs at the second deflectable cross-member portion 54 (each axially distal approximately ⅓ of the cross-member 24) rather than only at the mid-point. The second deflectable cross-member portion 54 is, then, the two end portions of the cross-member 24 spring at which the characteristic response of the spring to the load occurs. As the load increases further, a third initial tension of the spring may also be overcome, separating adjacent coils, and extending the spring which comprises a third deflectable cross-member portion 56. The third deflectable portion 56 could exist at any physical point along the spring, although it does not occur frequently. There will be some overlap in the ranges of loads that cause deflection of the first 52, second 54, and third 56 deflectable cross-member portions.

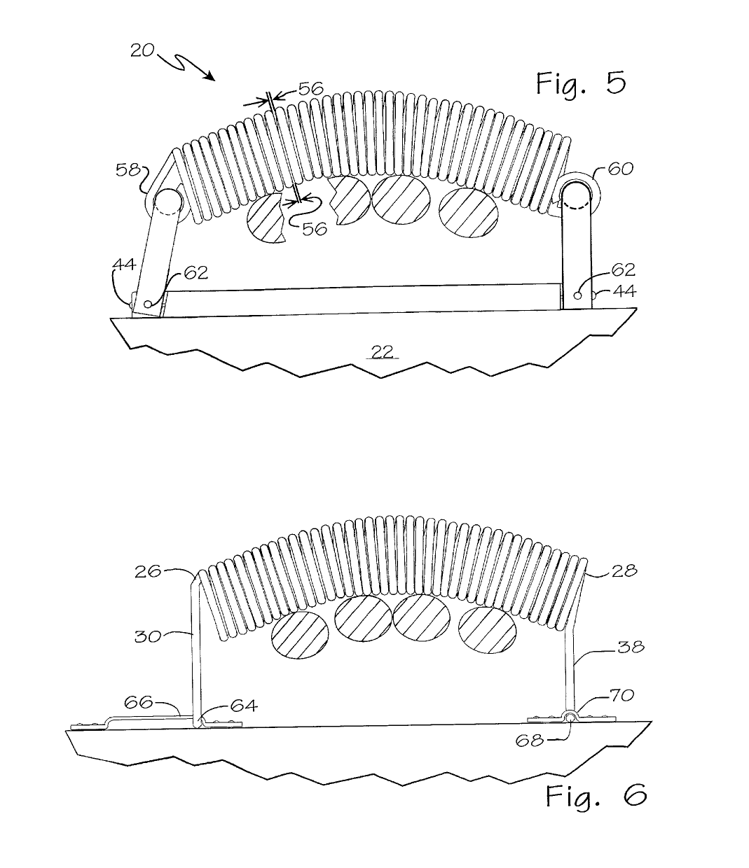

FIG. 5 shows the heavy load of FIG. 4 applied to alternative embodiments of the cross-member ends 26 28, links 30 38 and case attachment fixture 36. The cross member ends 26 28 may be terminated in a variety of manners such as an overhand loop 58 or an underhand loop 60. The ends 26 28 could also be terminated as pins extending at any desired angle, “T” ends, hooks, “L” ends, or other figures. Rings, grooves, sockets, splines, enlargements, or other features desired for attachment to links 30 38 may be formed, machined or attached to terminate the material at the cross-member ends 26 28.

The hinge pin 44 provides one optional structural means for articulating the link case end 34 42 on an axis parallel to the plane of the luggage 22. It may also be desirable for the link 30 to articulate perpendicular to the plane of the luggage 22 and a link case end swing pivot 62 may optionally be provided for that purpose.

FIG. 6 shows the heavy load configuration of the handle 20 as in FIG. 4 and FIG. 5. In FIG. 6, however, the links 30 38 are formed integrally with the cross-member ends 26 28. The first link case end 34 is depicted as being comprised of a loop-type mating fastener 64 that can slide along a slider type case attachment fixture 66. Yet another alternative embodiment is presented by the second link case end which is shown with a “T” or “L” termination 68 fitted into a semi-cylindrical-type case attachment fixture 70. It is to be understood that the links 30 38 may articulate with respect to the elongated cross-member 24 ends 26 28, even when the link is formed integrally with the elongated cross-member 24, when the links are formed of resilient material such as spring steel wire.

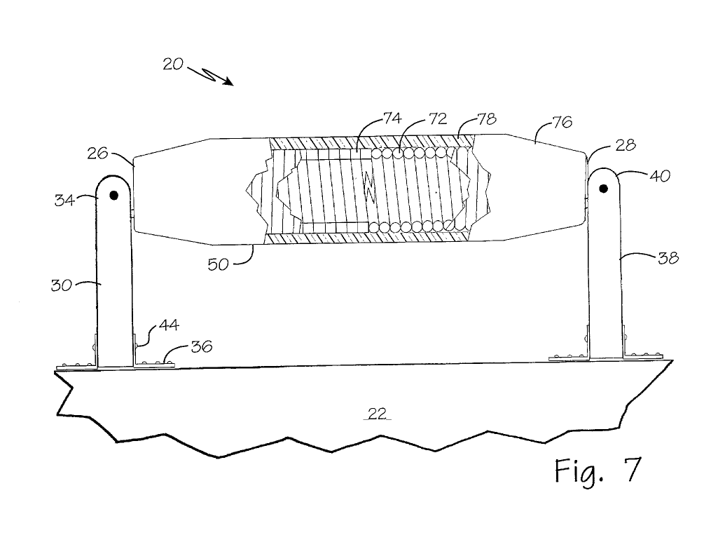

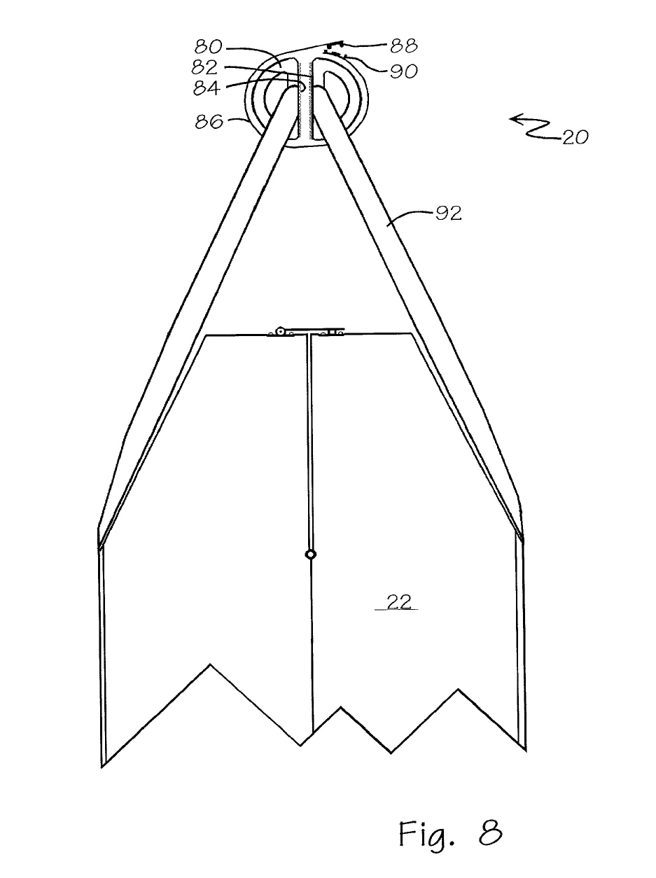

FIG. 7 shows additional alternative embodiments of the carry handle 20. The grippable cross-member 24 may be a close wound coil extension spring wound of round wire 72, rectangular wire 74 or materials of other sections. It is to be understood also that materials other than spring steel may be used equivalently to form the elongated cross-member 24 including polymers, composites, other metals and wood individually or in combination. The elongated cross-member 24 may optionally be wound with a portion that tapers 76 toward the ends 26 28. The cross-member 24 may also be wound in non-circular sections and may be wound with tapered wire or wire having other varying properties. The desired load response may be obtained by varying the coil diameter, the wire diameter, the coil shape, and the configuration of terminations at the ends of the cross-member 24.

The sheath portion 78 may be any flexible material such as leather and leather substitutes, cloth whether woven or non-woven, foamed rubber or plastic, or polymer film, including shrinkable films, or any combination of these materials, including combinations with other materials. Although other materials may be used to make the sheath 78, it is possible to make a comfortable sheath using a closed-cell neoprene foam that is about ⅛ in. thick. The foam may be wrapped, wrapped with lapping, or applied as a pre-formed cylinder. If the sheath 78 material is cylindrical, or tubular, and not shrinkable, it can be helpful to warm the sheath 78 material before it is applied. With some sheath materials, application of lubricants, soap, or moisture may aid placement of the sheath 78 over the cross-member 24.

Although the sheath 78 may be made of many different materials that are equivalent for the purposes of this disclosure, there are several desirable properties that make some materials better adapted for sheath 78 construction than others. Resilient materials are desirable so that the sheath can extend with the spring and maintain the same configuration with respect to the spring cross-member 24. Elastomers such as neoprene and urethane, among others, can be easily found commercially in sufficiently resilient formulations. Knit textiles, leather, and even some woven materials can be applied in sufficiently resilient configurations, such as bias or diagonal strand orientation. Some vinyl (and other polymer) sheet stock is sufficiently resilient to form a sheath without any special configuration techniques. So, too, can molded coverings be applied to the spring cross-member 24 to provide an aesthetically and tactually pleasing finished elongated grippable surface 50. The tie ends 32 40 of the links may extend to cover any opening or gap at the end of the cross-member 24.

FIG. 8 is an end elevation of another alternative embodiment of the ergonomic spring suspension carry handle 20. Some articles of luggage 22, especially soft-sided luggage, have paired handles, often incorporating webbing or strapping materials that support the case sides and may form a continuous web that passes under the bottom of the case to thereby obviate the failure of handles as the result of case attachment fixtures 36 separating from the top of the case 22. An alternative “D”-wound paired grippable cross member portion 80 may be formed to yield the benefits of this disclosure in connection with cases 22 of that type.

Two similar “D”-wound spring coils may be positioned with the flat sides adjacent to yield a comfortable, nearly cylindrical graspable cross-member portion 80 having properties of a coil spring having a circular section. It is possible to hold paired “D”-wound cross-members 80 adjacent with surface fasteners such as hook and loop fasteners, or other optional paired cross-member portion 82 on one coil and optional paired cross-member joinder mating fastener 84 affixed to the other member of the pair.

Alternatively, either paired or mating dual handles can be connected with an optional paired cross-member joinder sheath 86. The joinder sheath 86 can cover either similar handles such as paired “D”-wound coil springs 80 or dissimilar handles such as a helical-wound coil and a strap, panel, cylinder, etc. and may be integral with any of the other hand-graspable components. The joinder sheath 86 may be fitted with a joinder sheath fastener portion 88 such as a snap or hook elements near one end. Joinder sheath mating fastener 90 elements such as loops or snap fasteners may be attached to the other end of the joinder sheath 86. The joinder sheath 86 may be sewn to an alternative webbing-type link 92 to prevent loss and enhance usability. The webbing-type link 92 would comprise the case attachment fixture 36 by being sewn onto the luggage 22. The use of a joinder sheath 86 with paired spring-type cross-member elements is equivalent to use of a single coil with, or without attachment of a second webbing-type handle element to a coil.

Changes and modifications in the specifically described embodiments can be carried out without departing from the scope of the invention which is intended to be limited only by the scope of the appended claims.

### Drawings Reference Numbers and Descriptions of Elements

| Ref. | | Ref. | |
|---|---|---|---|
| No. | Description of Element | No. | Description of Element |
| 20 | grippable ergonomic spring | 56 | third deflectable cross- |
| | suspension carry handle | | member portion |
| 22 | luggage | 58 | overhand loop |
| 24 | elongated grippable cross- | 60 | underhand loop |
| | member portion | | |
| 26 | first end of grippable | 62 | link case end swing pivot |
| | cross-member | | |
| 28 | second end of grippable | 64 | loop-type first link case end |
| | cross-member | | portion |
| 30 | first link | 66 | slider-type case attachment |
| | | | fixture |
| 32 | first link tie end portion | 68 | “T” or “L” type second link |
| | | | case end portion |
| 34 | first link case end portion | 70 | semi-cylindrical-type case |
| | | | attachment fixture |
| 36 | case attachment fixture | 72 | round spring steel wire |
| 38 | second link | 74 | rectangular spring steel |
| | | | wire |
| 40 | second link tie end portion | 76 | taper portion |
| 42 | second link case end portion | 78 | sheath portion |
| 44 | hinge pin | 80 | alternative “D”-wound |
| | | | paired grippable |
| | | | cross-members |
| 46 | tie pivot | 82 | optional paired |
| | | | cross-member |
| | | | joinder fastener portion |
| 47 | loop or other mating fastener | 84 | optional paired |
| | | | cross-member |
| | | | joinder mating fastener |
| 48 | fingers | 86 | optional paired |
| | | | cross-member |
| | | | joinder sheath |
| 50 | elongated hand-contacting | 88 | joinder sheath fastener |
| | surface | | portion |
| 52 | first deflectable cross- | 90 | joinder sheath mating |
| | member portion | | fastener |
| 54 | second deflectable cross- | 92 | alternative webbing-type |
| | member portion | | link |

I claim:

1. A grippable carry handle assembly for attachment to a luggage case comprising:
a. two spaced-apart articulating case attachment fixtures,
b. two links, each link having a case end portion articulatingly connected to a case attachment fixture and a tie end portion attached to
c. an elongated grippable cross-member portion having a first end articulatingly connected to the first link tie end and a second end articulatingly connected to the second link tie end, the cross-member being further comprised of;
i. a first deflectable portion resiliently responsive to force applied to a link in excess of a first initial tension,
ii. a second deflectable portion resiliently responsive to force applied to a link in excess of a second initial tension,
iii. a third deflectable portion resiliently responsive to force applied to a link in excess of a third initial tension,
iv. a sheath portion generally radially surrounding the cross-member, and
v. an elongated hand-contacting surface generally surrounding the sheath portion.

2. A grippable carry handle assembly for attachment to a luggage case as defined in claim 1, wherein a close-wound, extension-type coil spring, comprises the cross-member, the coil spring being deflectable responsive to carrying force applied to a link.

3. A grippable carry handle assembly for attachment to a luggage case as defined in claim 2 wherein the case attachment fixture is further comprised of means for articulation of the links on an axis parallel to the plane of the luggage case.

4. A grippable carry handle assembly for attachment to a luggage case as defined in claim 3 wherein the link case end connection to the case attachment fixture further comprises means for articulation of the link on an axis perpendicular to the plane of the luggage case.

5. A grippable carry handle assembly for attachment to a luggage case as defined in claim 4 wherein the extension-type coil spring is wound having a diameter that varies along the length of the elongated, grippable cross-member.

6. A grippable carry handle assembly for attachment to a luggage case as defined in claim 5 wherein the extension-type coil spring is comprised of rectangular wire.

7. A grippable carry handle assembly for attachment to a luggage case as defined in claim 6 wherein the extension-type coil spring is wound having a diameter that varies along the length of the elongated, grippable cross-member.

8. A grippable carry handle assembly for attachment to a luggage case as defined in claim 1, wherein the links are further comprised of resilient material deflectable responsive to applied carrying force.

9. A grippable carry handle assembly for attachment to a luggage case as defined in claim 2, wherein the links are further comprised of resilient material deflectable responsive to applied carrying force.

10. A grippable carry handle assembly for attachment to a luggage case as defined in claim 9 wherein the case attachment fixture is further comprised of means for articulation of the links on an axis parallel to the plane of the luggage case.

11. A grippable carry handle assembly for attachment to a luggage case comprising:
a. two spaced-apart articulating case attachment fixtures having hinging means for articulation of the links on an axis parallel to the plane of the luggage case,
b. two links, each link having a case end portion articulatingly connected to a case attachment fixture and a tie end portion attached to
c. an elongated grippable cross-member portion made of a close-wound, extension-type coil spring, the cross-member, having a first end articulatingly connected to the first link tie end and a second end articulatingly connected to the second link tie end, the cross-member being further comprised of;
i. a first deflectable portion resiliently responsive to force applied to a link in excess of a first initial tension,
ii. a second deflectable portion resiliently responsive to force applied to a link in excess of a second initial tension,
iii. a third deflectable portion resiliently responsive to force applied to a link in excess of a third initial tension,
iv. a sheath portion generally radially surrounding the cross-member, and
v. an elongated hand-contacting surface generally surrounding the sheath portion.

12. A grippable carry handle assembly for attachment to a luggage case as defined in claim 11, wherein the coil spring is deflectable perpendicular to the elongated axis responsive to carrying force applied to a link.

13. A grippable carry handle assembly for attachment to a luggage case as defined in claim 11, wherein the coil spring is deflectable on the elongated axis responsive to carrying force applied to a link.

14. A grippable carry handle assembly for attachment to a luggage case as defined in claim 13, wherein the coil spring is deflectable perpendicular to the elongated axis responsive to carrying force applied to a link.

15. A grippable carry handle assembly for attachment to a luggage case as defined in claim 14 wherein the coil diameter of the cross-member is greater in the first deflectable portion than in the second deflectable portion.

16. A grippable carry handle assembly for attachment to a luggage case as defined in claim 11, wherein the coil spring is wound using rectangular wire.

17. A grippable carry handle assembly for attachment to a luggage case as defined in claim 13, wherein the coil spring is wound using rectangular wire.

18. A grippable carry handle assembly for attachment to a luggage case as defined in claim 14, wherein the coil spring is wound using rectangular wire.

19. A grippable carry handle assembly for attachment to a luggage case as defined in claim 15, wherein the coil spring is wound using rectangular wire.

20. A grippable carry handle assembly for attachment to a luggage case comprising:
a. two pairs of spaced-apart articulating case attachment fixtures, one pair of case attachment fixtures being on one side of a luggage case and the other pair of case attachment fixtures being located on the opposite side of the luggage case,
b. two pairs of links, each link having a case end portion articulatingly connected to a case attachment fixture and a tie end portion attached to
c. an elongated grippable cross-member portion having a first end articulatingly connected to the first link tie end and a second end articulatingly connected to the second link tie end, the cross-member being further comprised of;
i. a first deflectable portion resiliently responsive to force applied to a link in excess of a first initial tension,
ii. a second deflectable portion resiliently responsive to force applied to a link in excess of a second initial tension,
iii. a third deflectable portion resiliently responsive to force applied to a link in excess of a third initial tension,
iv. a sheath portion generally radially surrounding the cross-member, and
v. an elongated hand-contacting surface generally surrounding the sheath portion.
